(19) United States
(12) Patent Application Publication
(10) Pub. No.: US 2001/0035314 A1
(43) Pub. Date: Nov. 1, 2001

(54) Hall call input mode switch system

(76) Inventors: Takayuki Yoshida, Yokohama-shi (JP); Kenichi Ohmura, Kawasaki-shi (JP)

Correspondence Address: OTIS ELEVATOR COMPANY, INTELLECTUAL PROPERTY DEPARTMENT, 10 FARM SPRINGS, FARMINGTON, CT, 06032, US

(21) Appl. No.: 09/827,591

(22) Filed: Apr. 6, 2001

(30) Foreign Application Priority Data
Apr. 18, 2000 (JP) 2000-116141

(51) Int. Cl. B66B 1/18

(52) U.S. Cl. 187/382

(57) ABSTRACT

Corresponding to the operating system, the hall call button image is changed to a destination floor button, sector button, up/down button, etc.

### TECHNICAL FIELD

The present invention pertains to a hall call input-output mode switch system for an elevator that allows the change of display and input formats such as: elevator operation state. sector registration in a hall according to operation, direct floor registration, and up/down registration.

### BACKGROUND

When many persons enter a building to visit various offices, it is more efficient to carry the persons going to the upper floors, the persons going to the intermediate floors, and the persons going to the lower floors in separate elevators, rather than carrying them from the lowest floor to the highest floor in one elevator unit. Accordingly, a sector registration method that divides all the entire floors of a building into several sectors (each division is called a sector), wherein each elevator only carries persons to a floor within a single sector is the subject of copending application ______ based on Japanese priority Patent Application Nos. Hei 7[1995]-149480 and Hei 5[1993]-20628).

The above-mentioned sector registration method is explained using FIG. 5. In this example, elevator car 1 is not allowed to be registered to a sector. Elevator car 2 is registered to service the first sector (SN=1). Elevator car 3 services the second sector (SN=2), and elevator car 4 services the third sector (SN=3).

Since elevator car 1 is not allocated to a sector, it can service any floor. A floor service indicator (S1) for the elevator car 2 indicates the several floors allocated to the first sector, for example, the second to fifth floors, and said elevator car provides exclusive service to these floors from the lobby.

The elevator car 3 similarly provides service to the second sector consisting of the floors allocated to that sector, for example, the sixth to ninth floors. Also, the floor service indicator (S1) for elevator car 4 indicates the floors allocated to the third sector, that is, the 10th to 13th floors. In this configuration, a round-robin registration of elevator cars to sectors is used, therefore, the next sequential sector will be allocated to elevator car 1.

Each elevator car only responds to an elevator car call generated at the lobby level for a floor matching the floors in the sector allocated to that elevator car. For example, elevator car 4 only responds to an elevator car call for the 10th to 13th floors input at the lobby. The elevator car (if an elevator car call is generated for these floors) carries passengers to these floors from the lobby and returns in an empty state to the lobby unless it is directed to respond to hall calls.

Preferably the system collects data on demand and usage during one day based on operations of elevator car calls and hall calls, produces a history record of the traffic demands for each day of the week, compares it with estimated demands, and adjusts its general default programming.

As the sectors are allocated, the floor range of each sector is indicated by a screen (SI) installed in the vicinity of the door of each elevator on the lobby floor.

According to the above-mentioned elevator operating method, since the elevator provides service only within a specific range, the wait time and the service time can be reduced during the peak hours at the beginning and end of each workday in particular, however some drawbacks remain.

In the prior art system, the hall call fixture for elevators has typically been embodied in up/down buttons, individual floor buttons, etc., however once they are installed, they are fixed. Thus, only the installed call input method can be used. In special operating systems such as the above-mentioned sector operating system, if the hall buttons are fixed, the passenger input data are limited, and the wait time and service time are reduced, so that the performance improvement for group control is limited.

For example. if the hall buttons are up/down buttons, the passenger input data at the elevator lobby only contain the floor number and the up and down direction. As will be apparent to those skilled in the art, if the hall call input contains only the floor and the up or down information, various group control and operation mode decisions must still be made by the controller, and overall efficiency will deteriorate.

Also, even if a fixture for the input of complicated data is installed, it is useless for many simple operations, and passengers in the hall are likely to only be confused by its presence.

### SUMMARY OF THE INVENTION

The present invention considers the above-mentioned problems, and its purpose is to provide a hall call input-output mode switch system that can register a desired floor in accordance with the operating system of an elevator according to sectors or that can register a desired up/down direction or that can directly register a desired floor using a system such as a touch panel that can change its screen and its inputs.

The present invention is a hall call input mode switch system in an elevator control system wherein a hall call input control unit that has a hall call registration lantern is connected to the elevator communications system by which elevator control units communicate with each other. It consists of a hall call input display device that displays an image of the hall call button on the screen of a touchscreen, and a hall call display control unit that has the function of transmitting the hall call information input by passengers on the screen of the touchscreen to the hall call input control unit. The hall call input display device is capable of displaying screen data such as hall call buttons in several different display formats, switching the appearance of the touch screen to a hall call button screen of another display format when the hall call input system information is provided from the hall call input control unit. The hall call input display device and the hall call display control unit can be constituted by a touchscreen and a computer with a panel computer.

For example, if the elevator is operated in group control, a destination button screen is used, and in normal operation, an up/down button screen is used.

### BRIEF DESCRIPTION OF THE DRAWINGS

FIG. 1 is a block diagram showing a hall call input mode switch system.

FIG. 2 is an illustrative diagram showing the arrangement of a hall call input display device.

FIGS. 3(a), 3(b), 3(c) and 3(d) show examples of display screens of the hall call input display device.

FIG. 4 is a flow chart showing a hall call input control unit.

FIG. 5 is an illustrative diagram showing a conventional sector operating method.

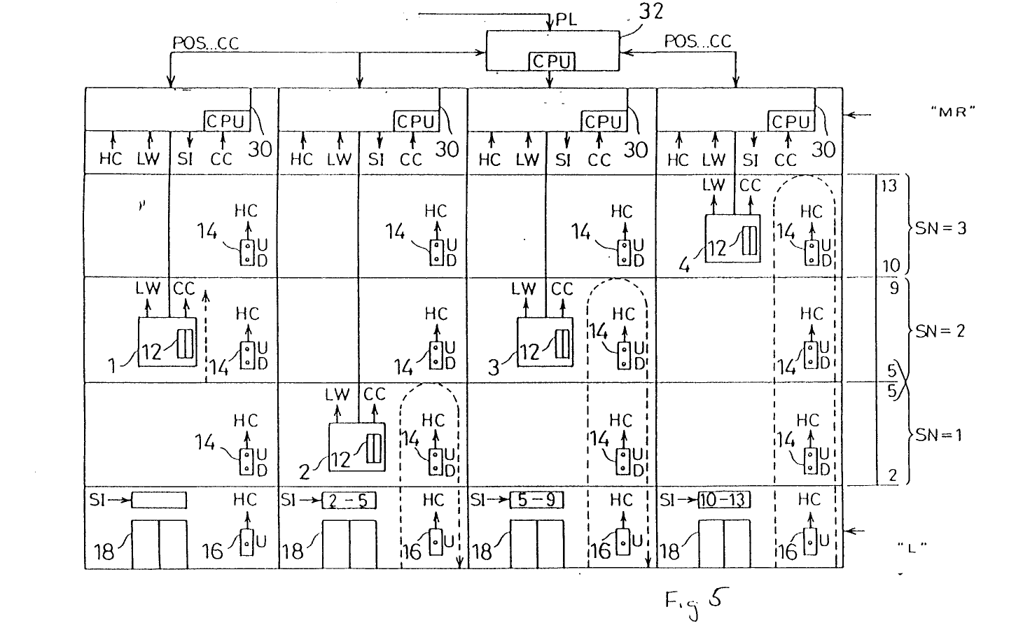

### BEST MODE

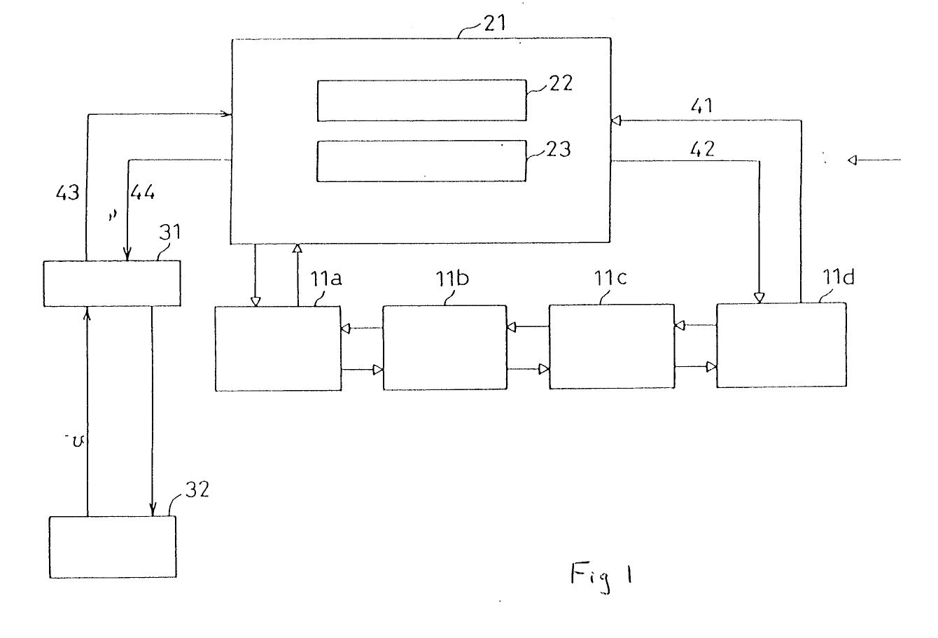

An embodiment of the present invention is explained using the figures. In FIG. 1, a hall call input control unit 21 having a hall call registration lantern 22 and a hall call input system information reading part 23 communication lines 41 and 42 with elevator control units 11a-11d of elevators units A-D which are in group-communication with each other.

A hall call input display device 32 and a hall call display control unit 31 are constituted by a touchscreen and a computer with a panel computer for the touchscreen. The hall call display control unit 31 is connected to the hall call input control unit 21 by lines 43 and 44.

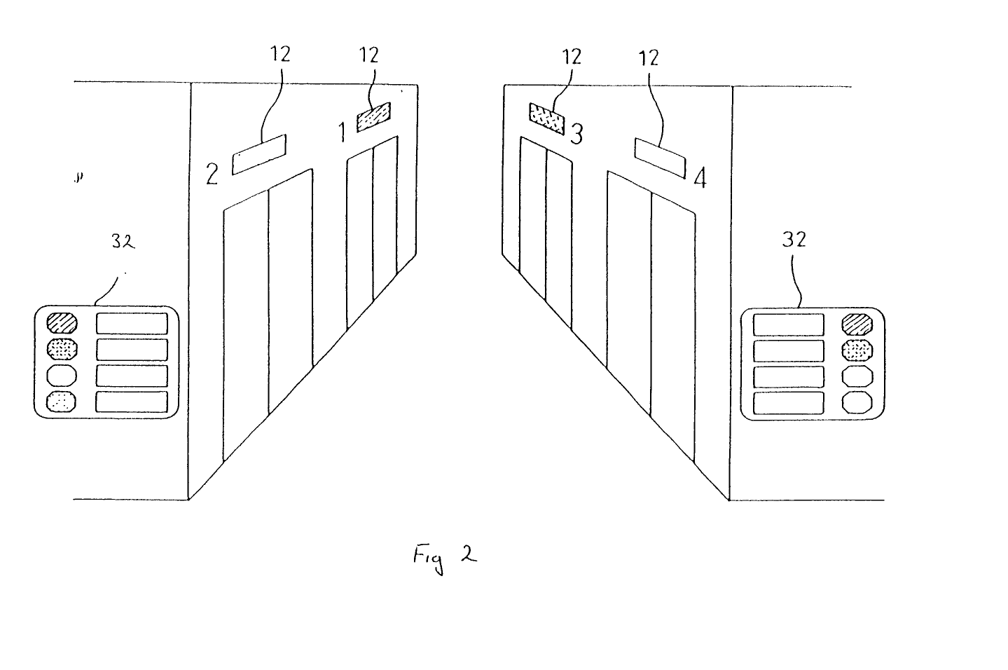

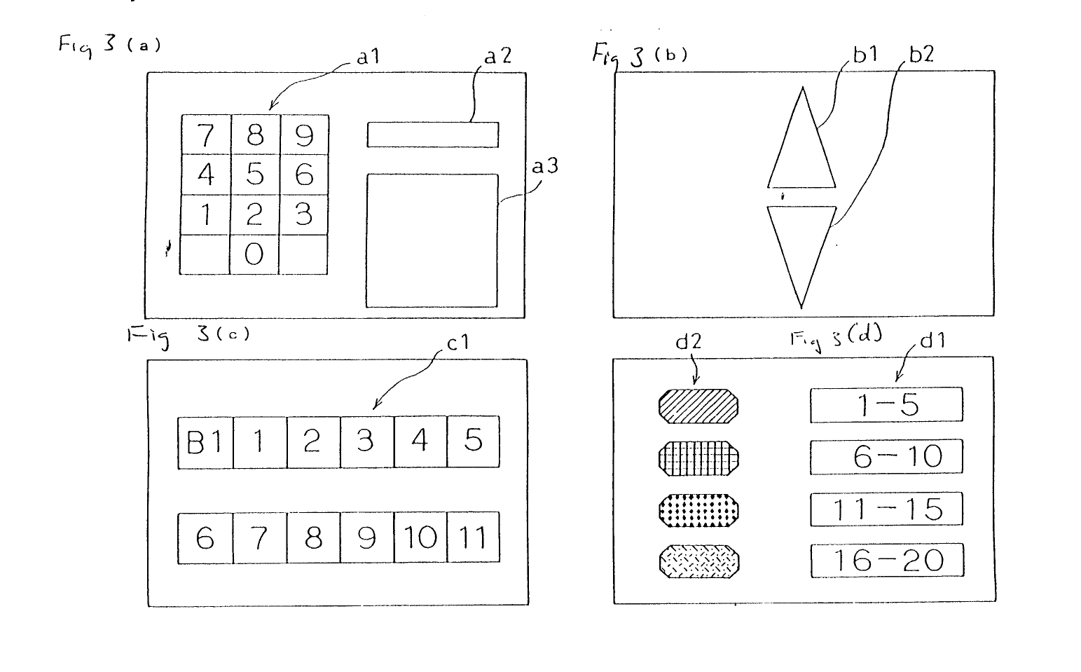

The hall call input display device 32, as shown in FIG. 2, is installed facing passengers in an elevator hall. FIG. 2 shows a screen for sector registration on the hall input display device, however, the hall call display control unit 31 can display several kinds of screens as shown in FIGS. 3(a)-(d). The system is programmed so that, depending on the hall call input system information received from the hall call input control unit 21, a stored screen is selected and image data are output to the hall call input display device 32.

In this embodiment, two screens, the up/down button screen of FIG. 3(b) and the destination floor registration screen of FIG. 3c, are stored in the hall call display control unit 31. The hall call input display device 32, responsive to the hall call display control unit 31, displays the selected image on its screen, and if a the screen is touched, senses the location of the touch and registers the user input appropriately.

The operation of this system is explained. In the event of a large number of passengers in the lobby awaiting the elevators, the elevator control units 11a-11d can reduce the wait time and the service time by improving the group control performance. Via the group communication network, the elevator control units 11a-11d notify the hall call input control unit 21 to switch into the destination floor registration mode.

The hall call control unit 21 receives the notification and outputs an instruction to display the destination floor registration screen to the hall call display control unit 31. The hall call display control unit 31 causes the hall call input display device 32 to display the stored destination registration screen (FIG. 3(c)) according to the instruction and waits for input.

The passengers in the hall touch the button of their desired floors on the screen (FIG. 3(c)) of the hall call input display device 32. The hall call display control unit 31 recognizes that a button has been pressed by the function of the touchscreen and notifies the hall call input control unit 21 of the selected floor. The hall call input control unit 21 transfers the desired floor of the passengers to the elevator control units 11a-11d by the group communication network. After receiving the call registration information, the elevator control units 11a-11d control the elevators so that the group control performance is improved.

Later, when the number of elevator passengers is reduced and the destination floor registration mode is not required to maintain elevator group performance, request to switch to an up/down registration mode is transferred from the elevator control units 11a-11d via the hall call input control device 21 to the hall call display control unit 31, and the screen of the touchscreen 32 is switched from the destination registration screen (FIG. 3(c)) to the up/down button screen (FIG. 3(b)). In this mode, the “up” or “down” button of the up/down button is pressed the up or down call registration information is sent from the hall call display control unit 31 to the hall call input control unit 21, registered, and sent to the elevator control units 11a-11d. As the call registration information is received, the elevator control units 11a-11d control the elevator group according to the operative control mode for the case of few passengers.

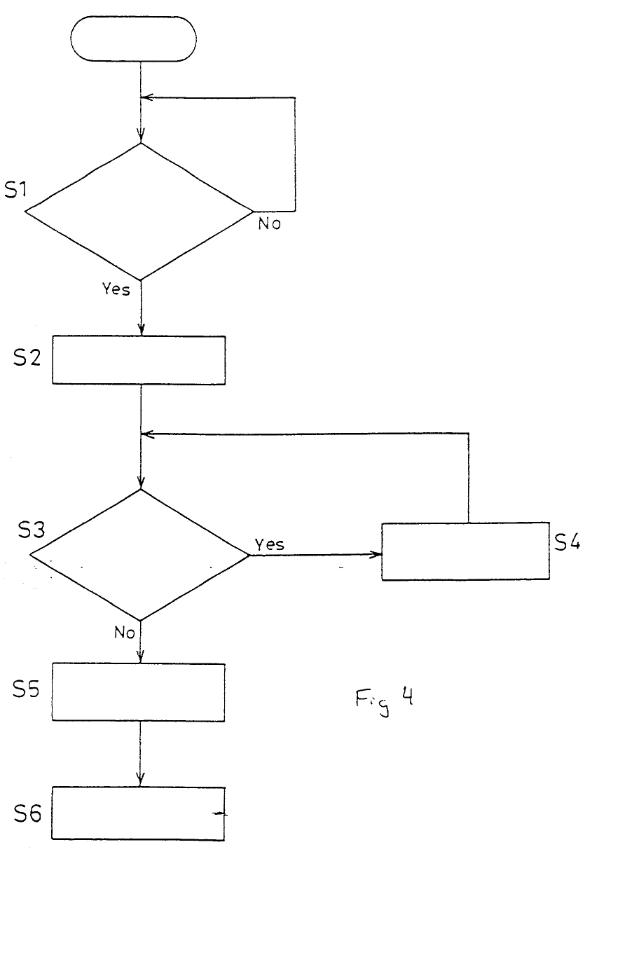

During transition periods, when the number of said users changes greatly, the processing of the hall call input control unit 21 can be explained using FIG. 4. Now, suppose that the screen of the touchscreen 32 of the hall is the destination registration screen (FIG. 3(c)) and the elevator group is operated in the destination floor registration mode (old mode).

The hall call input control unit 21 constantly monitors whether or not a request to switch to another mode operation is transmitted from the elevator control units 11a-11d, and if the decision result is Yes, the new mode operation information is received and stored, and it is determined if the selection is the currently operative mode (S1-S3).

If the requested mode is identical as the current mode of operation the elevator continues to operate in the current operative mode. If the requested mode is not the currently operative mode. the new mode is substituted for the old mode, and the new mode is started. For this example, the group control mode would change to the up/down registration mode, and the screen of the hall call input display device 32 would change to the screen (FIG. 3(b)) of the up/down button, and the user input in the lobby is carried out by up/down buttons.

In order to assist the users, in the event a destination floor button c1 of FIG. 3(c) is pressed on the hall call input control unit 21 and a desired floor is registered in the hall call display control unit 31, the image of the destination floor button pressed changes it's appearance, thereby providing the person who has pressed the button a visual feedback reference. Similarly, if an up or down button b1 or b2 of FIG. 3(b) is pressed and the up or down direction is set in the hall call registration, the pressed up or down button image is changed temporarily, and the hall call registration is notified to the user.

FIG. 3(a) is an example in which a destination floor may be registered by a ten-key keypad al and the selected destination floor, is displayed a2 along with a registered floor list display a3. FIG. 3(d) shows a sector registration example. In this mode, if a sector is registered by pressing a sector button d1 on which a range of floors are displayed, such as 1-5, 6-10, 11-15, and 16-20, the pressed sector button is lit, and a sector registration display lamp d2 displaying which the elevator unit is allocated to the sector is also lit. In this case, as shown in FIG. 2, an elevator registration display lamp 12 with the same display pattern (the indicated by color or shape) as that of the unit display button d2 is installed near the hall door for each elevator, so that the person who has pressed the sector button can easily recognize the elevator that he or she needs to board.

As described above, the present invention achieves the following benefits:

Hall call registration is achieved by touching an image displayed on a touch screen installed facing passengers in the hall.

Since the fixture display image can be drawn freely by the system, the input screen can be switched between up/down buttons, destination floor buttons of the hall, etc.

Hall data required for the group control be input from the passengers in the hall by switching the input screen in accordance with the operating system, so that the performance of group control is improved, thereby reducing wait time and service time.

With the display of the input screen as needed, confusion in the passengers using the hall buttons can be eliminated.

1. A hall call input mode switch system for receiving destination input for an elevator group having a plurality of elevators serving a plurality of levels, said levels being divisible into a plurality of sectors,
characterized in that
said elevator group includes a controller operable in a plurality of different destination input modes, and wherein the hall call input mode switch system further comprises a hall display including a touch screen capable of displaying a plurality of different images, each image configured so as to present the user with the opportunity to input destination information compatible with the current destination information entry mode of the group controller, and wherein user destination information input by the user to the touch screen is returned to the group controller.

2. The hall call input mode switch system as recited in claim 1, wherein the group controller is configured to recognize a change in user demand and initiates a request to change input mode to the hall display, and wherein
the hall display, responsive to said request to change mode, displays another image on the touch screen corresponding to the requested destination entry mode.

3. The hall call input mode switch system as recited in claim 1, further comprising
a plurality of sector indicators, each sector indicator corresponding to an elevator in the elevator group and disposed adjacent to a hall entry thereof,
wherein the different images displayable by the touch screen includes at least one image associating a sector of floor levels with a unique display image, said display image being reproduced by the sector display for the corresponding elevator servicing said sector.

4. The hall call input mode switch system as recited in claim 1, further characterized in that the different images of the hall display are selected from one of a destination floor input image or an up/down destination image.
